(19) United States
(12) Patent Application Publication
(10) Pub. No.: US 2012/0323777 A1
(43) Pub. Date: Dec. 20, 2012

(54) BUSINESS TO BUSINESS MOBILE VAULT

(76) Inventor: Michael A. Liberty, Windermere, FL (US)

(21) Appl. No.: 13/527,466

(22) Filed: Jun. 19, 2012

Related U.S. Application Data
(60) Provisional application No. 61/498,957, filed on Jun. 20, 2011.
(60) Provisional application No. 61/522,099, filed on Aug. 10, 2011.

(51) Int. Cl. G06Q 20/36; G06Q 20/32

(52) U.S. Cl. 705/41

(57) ABSTRACT

Embodiments extend to methods, systems, and computer program products for a business to business mobile vault. Embodiments allow retailers to pay distributors electronically through the use of a mobile device such as a mobile phone. Electronic payment through a mobile phone is more efficient than a currency transaction and reduces the amount of currency that delivery and distributor personnel handle. Further, mobile phone communication is available in many geographic locations, and in some geographic locations is the only form of communication available. Thus, electronic payment through a mobile phone can often be used even when other computer systems and specialized equipment such as point of sale terminals are not available or are not used, and when other types of data connections are not available.

### CROSS-REFERENCE TO RELATED APPLICATIONS

This application claims priority to and the benefit of U.S. Provisional Patent Application Ser. No. 61/498,957, filed on Jun. 20, 2011, entitled “Business to Business Mobile Vault,” which is incorporated by reference herein in its entirety. This application further claims priority to and the benefit of U.S. patent application Ser. No. 13/484,199, entitled “Monetary Transaction System”, filed on May 30, 2012, which itself claims priority to U.S. Provisional Application Ser. No. 61/522,099, filed on Aug. 10, 2011, entitled “Mobile Wallet Platform”, and U.S. Provisional Application Ser. No. 61/493,064, filed on Jun. 3, 2011, entitled “Mobile Wallet Platform”. Each of the aforementioned applications is incorporated by reference herein in its entirety.

### BACKGROUND

Mobile phones and other digital devices have become increasingly popular in recent years. Many mobile device users use their devices to perform countless different daily tasks. For instance, mobile devices allow users to check email, send and receive instant messages, check calendar items, take notes, set up reminders, browse the internet, play games or perform any number of different actions using specialized applications or “apps”. These applications allow mobile devices to communicate with other computer systems and perform a wide variety of network-connected tasks previously not possible with a mobile device).

### BRIEF SUMMARY

Embodiments of the present invention extend to methods, systems, and computer program products for a business to business mobile vault. Embodiments allow retailers to pay distributors (vendors) electronically through the use of a mobile device such as a mobile phone, tablet or other electronic device. Electronic payment through a mobile device is more efficient than a currency transaction and reduces the amount of currency that delivery and distributor personnel handle. Further, mobile communication is available in many geographic locations, and in some geographic locations is the only form of communication available. Thus, electronic payment through a mobile device can often be used even when other computer systems and specialized equipment (e.g., point of sale terminals) are not available or are not used, and when other types of data connections are not available.

Embodiments described herein include mobile devices such as mobile phones or tablets interoperating with an electronic payment system to invoice, pay for, and track the payment for delivered goods. A merchant mobile device runs a mobile wallet application that interacts with a merchant mobile wallet at the electronic payment system. A delivery personnel mobile phone runs an invoicing application that interacts with a distributor mobile vault. Embodiments of the invention can be used to both speed up the delivery personnel/merchant transaction (allowing more deliveries per day) and reduce the amount of currency handled by delivery personnel and distributors.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a monetary transaction system architecture in which embodiments described herein may operate.

FIG. 2 illustrates an alternate example embodiment of a monetary transaction system.

FIGS. 3A and 3B illustrate example data flows for performing subscriber-to-subscriber and subscriber-to-non-subscriber eMoney transfers via a mobile wallet, respectively.

FIG. 4 illustrates a monetary transaction system architecture in which embodiments including business to business mobile transactions may take place.

FIG. 5 illustrates an example data flow for allowing a merchant to pay a distributor for delivered goods using an electronic payment system.

### DETAILED DESCRIPTION

Embodiments of the present invention extend to methods, systems, and computer program products for a business to business mobile vault. Embodiments allow retailers to pay distributors (vendors) electronically through the use of a mobile device such as a mobile phone, tablet or other electronic device. Electronic payment through a mobile device is more efficient than a currency transaction and reduces the amount of currency that delivery and distributor personnel handle. Further, mobile communication is available in many geographic locations, and in some geographic locations is the only form of communication available. Thus, electronic payment through a mobile device can often be used even when other computer systems and specialized equipment (e.g., point of sale terminals) are not available or are not used, and when other types of data connections are not available.

Embodiments described herein include mobile devices such as mobile phones or tablets interoperating with an electronic payment system to invoice, pay for, and track the payment for delivered goods. A merchant mobile device runs a mobile wallet application that interacts with a merchant mobile walled at the electronic payment system. A delivery personnel mobile phone runs an invoicing application that interacts with a distributor mobile vault. Embodiments of the invention can be used to both speed up the delivery personnel/merchant transaction (allowing more deliveries per day) and reduce the amount of currency handled by delivery personnel and distributors.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions in the form of data are computer storage media. Computer-readable media that carry computer-executable instructions are transmission media. Thus, by way of example, and not limitation, embodiments described herein can comprise at least two distinctly different kinds of computer-readable media: computer storage media and transmission media.

Computer storage media includes RAM, ROM, EEPROM, CD-ROM, solid state drives (SSDs) that are based on RAM, Flash memory, phase-change memory (PCM), or other types of memory, or other optical disk storage, magnetic disk storage or other magnetic storage devices, or any other medium which can be used to store desired program code means in the form of computer-executable instructions, data or data structures and which can be accessed by a general purpose or special purpose computer.

A “network” is defined as one or more data links and/or data switches that enable the transport of electronic data between computer systems and/or modules and/or other electronic devices. When information is transferred or provided over a network (either hardwired, wireless, or a combination of hardwired or wireless) to a computer, the computer properly views the connection as a transmission medium. Transmission media can include a network which can be used to carry data or desired program code means in the form of computer-executable instructions or in the form of data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”), and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that various embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. Embodiments described herein may also be practiced in distributed system environments where local and remote computer systems that are linked (either by hardwired data links, wireless data links, or by a combination of hardwired and wireless data links) through a network, each perform tasks (e.g. cloud computing, cloud services and the like). In a distributed system environment, program modules may be located in both local and remote memory storage devices.

In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For instance, cloud computing is currently employed in the marketplace so as to offer ubiquitous and convenient on-demand access to the shared pool of configurable computing resources. Furthermore, the shared pool of configurable computing resources can be rapidly provisioned via virtualization and released with low management effort or service provider interaction, and then scaled accordingly.

A cloud computing model can be composed of various characteristics such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth. In this description and in the claims, a “cloud computing environment” is an environment in which cloud computing is employed.

Additionally or alternatively, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), and other types of programmable hardware.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

Various terminology will be used herein to describe the monetary transaction system (also referred to as a “mobile wallet platform”, “mobile wallet program”, “mobile wallet transaction system”, “mobile financial services (mFS) platform” or “electronic payment system”). The term “agent” is used to refer to an individual with mFS transaction system tools and training to support specific mFS functions. These mFS functions include subscriber registration and activation, and the deposit and withdrawal of funds from the mFS transaction system. Agents are representatives of the mFS transaction system or “program”. Agents can be employees or contractors of the program provider, or other companies and organizations that partner with the program provider to provide these services themselves. Agents may be found in every facet of a typical economy, and may include large retailers, mobile network operators (MNO) airtime sales agents, gas stations, kiosks, or other places of business.

The mobile wallet platform includes a mobile wallet application, web interface or some other type of functionality that allows the user to interact with the mFS platform using their mobile device. The mobile wallet application may include a subscriber identity module (SIM) application, an Unstructured Supplementary Service Data (USSD) application, a smartphone application, a web application, a mobile web application, a Wireless Application Protocol (WAP) application, a Java 2 Platform, Micro Edition (J2ME) application, a tablet application or any other type of application or interface that provides tools for the agent to register, activate, and offer other services to the mFS subscriber.

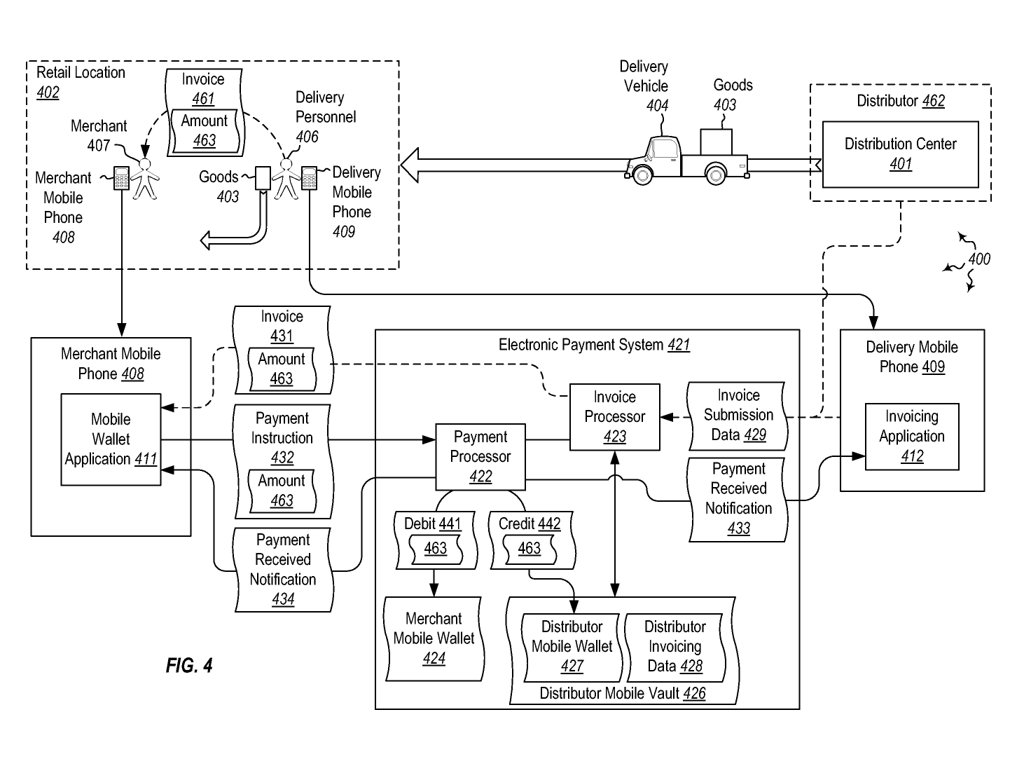

The mobile wallet platform may also include a mobile vault (such as distributor mobile vault 426 in FIG. 4). The mobile vault may include a mobile wallet as well as other items including invoicing data. A mobile vault may be used by merchants, distributors or other users to store value (e.g. on the mobile wallet) or other important information such as invoicing data. The mobile vault allows cash (and its corresponding logistical problems) to be replaced with mobile-enabled payment collection and digital invoicing, as well as providing a mobile point of sale (mPOS) for distributors (as will be described further below).

As used herein, a mobile wallet application is a mobile wallet application installed on a mobile device, in some cases on the device's SIM card. The mobile wallet application of a merchant may interact with the mobile wallet of a distributor distributor which is stored in the distributor's mobile vault. A USSD application is an application that implements USSD for various functionality including prepaid callback service, location-based content services, menu-based information services and other mobile wallet platform services. A web application is one that implements or uses the internet to provide mobile wallet platform functionality. A mobile web application is similar to a web application, but is tailored for mobile devices. A WAP application is one that uses the wireless application protocol to communicate with the mobile wallet platform to provide the platform's functionality. A J2ME application is an application developed in Java and is designed to provide mobile wallet functionality on a variety of different hardware. A tablet application is an application specifically designed for a touchscreen-based tablet that provides mobile wallet platform functionality for tablet devices, and as part of configuring the phone on the network. Any of these applications (or any combination thereof) may be provided on the user's mobile device. This functionality can also be made available on a retail point of sale (POS) system or web site.

The term “agent administrator” refers to an individual with mFS program tools and training to administrate the allocation of funds to agent branches (e.g. retail locations). As agents perform mFS transactions with subscribers, such as depositing and withdrawing money, the agents are adding and removing money from their own accounts. Any of the applications referred to above may be configured to provide tools used by the agent administrator to view the agent company balance, view the agent branch balances, and transfer funds into and out of agent branch mobile wallets. This functionality can also be made available on a website for easier access.

In some embodiments, the mFS platform application and/or the mobile vault may utilize triple data encryption standard (3DES) encryption (or some other type of encryption), encrypted message signing, and password security on some or all of its communications with the mFS transaction system in order to ensure that the transactions are properly secured and authenticated.

The term “agent branch” refers to any location where an agent provides support for subscriber services of the mFS platform. Funds are allocated by the agent administrator from the agent company's main account to each agent branch to fund the subscriber mFS functions such as depositing or withdrawing cash, in-store purchases, bill payments, prepaid airtime top-ups and money transfers. In some cases, multiple agents may work in a single branch. However, at least in some cases, monetary funds are allocated to from the agent company's main account on a per branch basis.

The term “agent branch account balance” refers to the amount of money residing in a particular agent branch account at a given time. Funds can be deposited into the branch account by the agent administrator, or the funds can come from participating in subscriber mFS transactions such as depositing or withdrawing cash from the subscriber's mobile wallet accounts, or making retail purchases with the mobile wallet.

In some embodiments, in countries with more developed economies, it may be beneficial to use program-issued pre-paid debit cards, pre-paid access accounts, stored value accounts or gift cards to conduct business along with the added convenience of card processing networks such as Cirrus, STAR, or Visa for POS and automated teller machine (ATM) functionality. Agents, particularly those in retail outlets and kiosks, can still support subscribers with deposits, withdrawals, and other transfers, but in this case bank external card processors manage the mobile wallet and branch account balances and provide the real-time transfer of funds.

The term “agent branch ledger” refers to a written (or electronic) ledger maintained by the mFS platform. Agent branch transactions are performed on the agent's and subscriber's mobile phones where an electronic record of the transaction is generated and stored on the mFS platform. These electronic transactions are then reconciled with agent branch ledgers to ensure the security and integrity of the transaction. Agent branch ledgers are printed or electronic transaction logs that are distributed to the agent branch locations in hard copy form to serve as a backup record to the electronic transactions.

The term “agent company” refers to a business that registers to participate in the mFS program as a partner of the mFS program provider or owner. The agent company has one or more agent branches which conduct mFS business with mFS program subscribers. In some cases, the agent company may be referred to as a distributor or retailer.

The term “agent company account balance” refers to the sum of the funds deposited at a “partner bank” (defined below) by the agent company to fund the agent company's daily transactions. The funds in the agent company account are then distributed to agent branches by the agent company's agent administrator to conduct everyday business such as accepting cash deposits and cash withdrawals from mFS subscribers. This balance is sometimes referred to as the “agent company float”.

An “agent manager” is a supervisor of company agents for a given company. The agent manager has the training and tools to create, delete or modify agent accounts for a company, as well as monitor the transactions performed by agents. The agent manager may have a special application or an increased level of rights to access applications features not available to other users. The special application is a program installed on the agent manager's terminal. This application provides the agent manager the ability to securely perform agent manager functions such as registering and activating new agent accounts. The mFS agent manager application may be installed on any terminal or device. It communicates with the mFS platform using binary and/or text SMS messages. A wireless service provider or MNO provides the GSM SMS network infrastructure on which the mFS platform operates. In some embodiments, the mFS agent manager application itself be a mobile vault providing business-to-business cashless transactions, including other functions. In other embodiments, the mFS agent manager application may provide mobile wallet application functions and/or mobile vault functions. System-specific permissions may dictate which functions are available on each mFS agent manager application.

As subscribers, agents, and other mFS program participants conduct business in the mFS program, value is transferred from one account to the next as payment for services rendered or goods purchased. This value can be in the form of real currency or the electronic representation referred to herein as eMoney. Among other situations, eMoney is used in mFS implementations where the real-time processing of financial transactions including card processing is not practical. The mFS platform utilizes an internal transaction processor for managing the real-time balance of mobile wallet and agent accounts as value (eMoney) is transferred from one mobile wallet to another in payment for services.

The term “mFS program master account” refers to a bank account maintained by the mFS program partner bank to provide funds and float for the operation of the mFS platform. Depending on the type of mFS implementation, the master account can include sub-accounts for each of the agent branches and subscriber mobile wallets, giving the bank visibility into all transactions on a per-user basis. The mFS platform can also manage the balance of sub-accounts and interact with the bank's master account when funds need to be deposited or withdrawn from the account.

The term mobile network operator (MNO) refers to a provider of mobile phone service including basic voice, SMS, unstructured supplementary service data (USSD) and data service, and may also be referred to as a “wireless service provider”.

The term “mobile wallet” or “mobile wallet account” refers to a stored value account or prepaid access account (PPA) that allows the owner (or “subscriber”) to pay for goods and services on the mFS platform from his or her mobile wallet account. When the mFS eMoney transaction processor is used, the mobile wallet balance is maintained by the mFS platform and value is exchanged within the mFS program as eMoney. When the mFS platform is integrated to an external card processor, the mobile wallet utilizes funds from the subscriber's prepaid debit card and bank account to exchange value on the mFS platform.

The term “partner bank” refers to the primary bank participating in the mFS program. The partner bank is responsible for holding the mFS program master accounts that hold the funds for all mFS services and transactions. A “PIN” refers to a numeric password that may be required to perform a transaction via the mobile wallet application.

The term “subscriber” refers to a participant of the mFS mobile wallet platform. The subscriber maintains a mobile wallet balance and performs transactions using the mFS application. An “unbanked subscriber” is a subscriber that does not have (or does not have access to) a bank account or credit union account. The application or “mobile wallet application” provides mobile wallet functionality to the (unbanked) subscriber. The mobile wallet application is installed on a mobile device in the device's memory, on a SIM card (such as a GSM SIM card) or is otherwise accessible to the mobile device. The mobile wallet application provides the subscriber the ability to securely perform subscriber functions such as making retail purchases, paying bills, or transferring money to other mFS subscribers and non-subscribers. The mobile wallet application communicates with the mFS platform using binary and text SMS messages, among other forms of wireless communication. A wireless service provider or MNO provides the GSM network infrastructure on which the mFS platform operates.

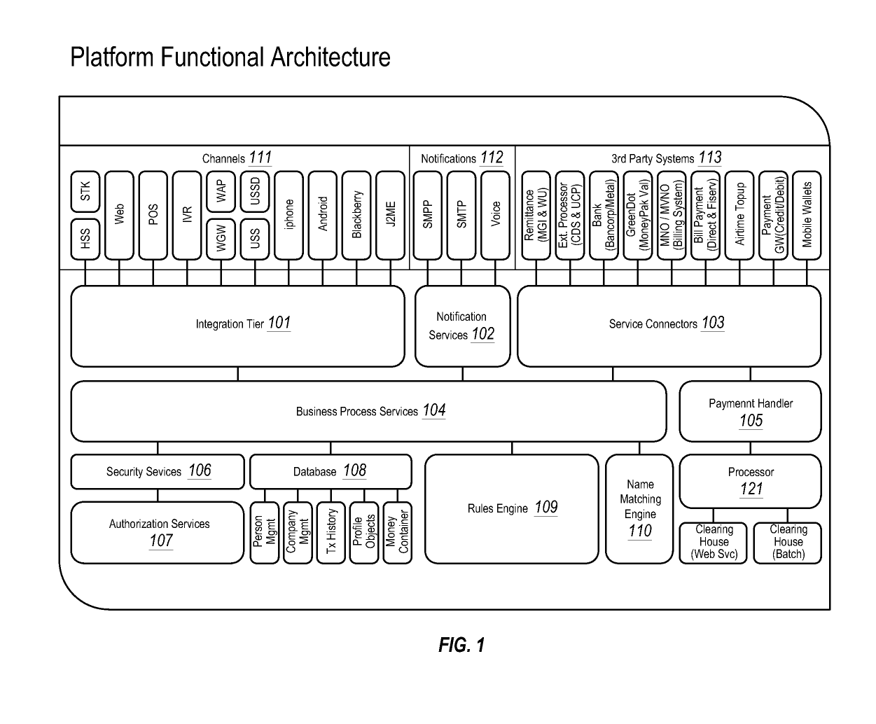

FIG. 1 illustrates an example system architecture for a mobile wallet platform. Integration tier 101 is configured to manage mobile wallet sessions and maintain integrity of financial transactions. Integration tier 101 can also include a communication (e.g., Web services) API and/or other communication mechanisms to accept messages from channels 111. Other mechanisms include, but are not limited to: International Standards Organization (“ISO”) 8583 for Point of Sale (“POS”) and Automated Teller Machines (“ATM”) devices and Advanced Message Queuing Protocol (“AMQP”) for queue based interfaces. Each of channels 111 can be integrated to one or more mechanisms for sending messages to integration tier 101. Notification services 102 is configured to send various notifications through different notification channels 112, such as, for example, Short Message Peer-to-Peer (“SSMP”) for Short Messaging Service (“SMS”) and Simple Mail Transfer Protocol (“SMTP”) for emails. Notification services 102 can be configured through a web services API.

Service connectors 103 are a set of connectors configure to connect to 3rd party systems 113. Each connector can be a separate module intended to integrate an external service to the system architecture. Business process services 104 are configured to implement business workflows, including executing financial transactions, auditing financial transactions, invoking third-party services, handling errors, and logging platform objects. Payment handler 105 is configured to wrap APIs of different payment processors, such as, for example, banking accounts, credit/debit cards or processor 121. Payment handler 105 exposes a common API to facilitate interactions with many different kinds of payment processors.

Security services 106 are configured to perform subscriber authentication. Authorization services 107 are configured to perform client authorization, such as, for example, using a database-based Access Control List (“ACL”) table.

Database 108 is configured to manage customer accounts (e.g., storing customer accounts and properties), manage company accounts (e.g., storing company accounts and properties), manage transaction histories (e.g., storing financial transaction details), store customer profiles, storing dictionaries used by the mobile wallet platform, such as, for example, countries, currencies, etc., and managing money containers. Rules engine 109 is configured to gather financial transaction statistics and uses the statistics to provide transaction properties, such as, for example, fees and bonuses. Rules engine 109 is also configured to enforce business constraints, such as, for example, transactions and platform license constraints.

Name matching engine 110 is configured to match different objects according to specified configuration rules. Matching engine 110 can be use to find similarities between names, addresses, etc. Transaction processor 121 is configured to manage financial accounts and transactions. The transaction processor 121 can be used to hold, load, withdraw and deposit funds to mobile wallet accounts. Transaction processor 121 can also be used as a common interface to a third party processor system. When used as a common interface, financial operations may be delegated to the external processor. A Clearing House subsystem of transaction processor 121 can be used to exchange the financial information with a bank.

Components of a mobile wallet platform can be connected to one another over (or be part of) a system bus and/or a network. Networks can include a Local Area Network (“LAN”), a Wide Area Network (“WAN”), and even the Internet. Accordingly, components of the mobile wallet platform can be “in the cloud”. As such, mobile wallet platform components as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the system bus and/or network.

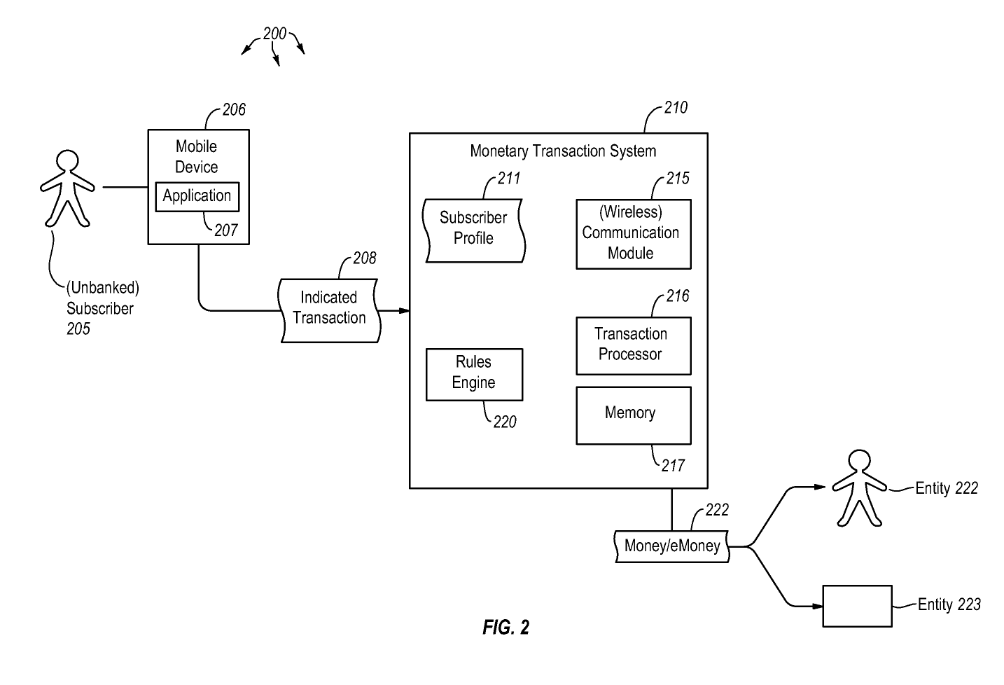

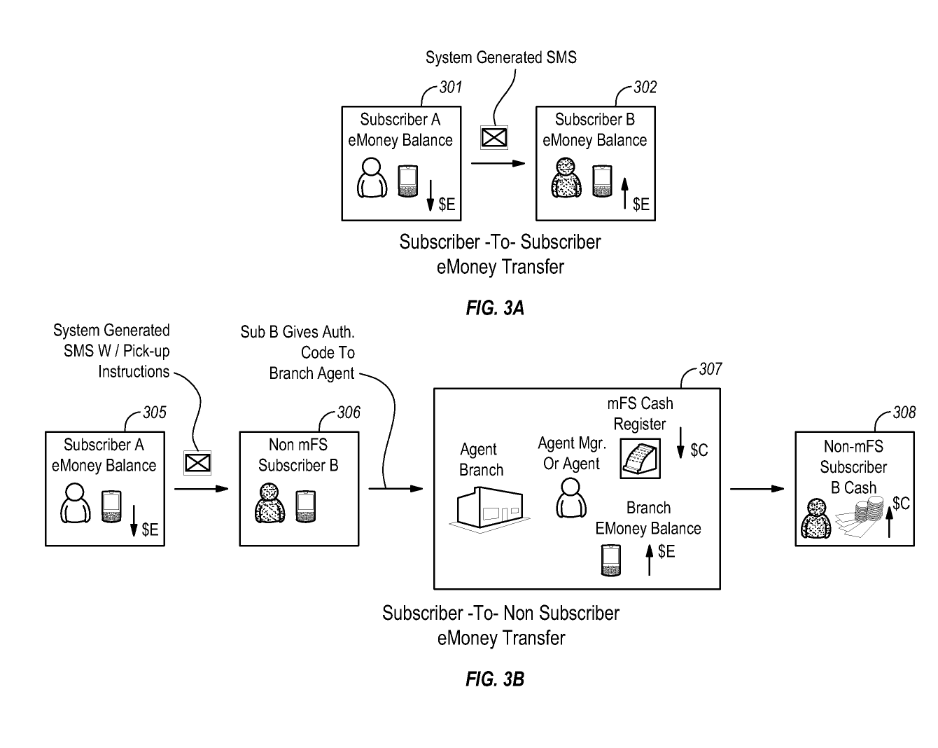

The components depicted in FIG. 1 can interoperate to provide a number of financial and other services including but not limited to enrolling a customer for a mobile wallet, adding a stored value account (either hosted by a mobile wallet platform or a third party), adding a bank or credit union account to a mobile wallet, adding a debit or credit card account to a mobile wallet, depositing funds in a mobile wallet, withdrawing funds from a mobile wallet, paying bills from a mobile wallet, topping up a prepaid mobile account through a mobile wallet, transferring funds through a mobile wallet (nationally or internationally), making in-store purchases using a mobile wallet, and various other tasks as described herein below. These services will be described in greater detail below with regard to system FIGS. 1 and 2, as well as FIGS. 3-19B.

FIG. 2 depicts a monetary transaction system 200 similar to that described in FIG. 1. The monetary transaction system 200 may provide a more simplified system structure in which each of the above services may be provided. The system includes a subscriber 205. The subscriber may have access to a bank account, or may be an unbanked subscriber. The subscriber has a profile 211 with the monetary transaction system 210. The profile includes the subscriber's know your customer (KYC) information, as well as any associated bank accounts, credit union accounts, bill pay accounts or other accounts. The subscriber has (or has access to) a mobile device 206 such as a phone or tablet. The mobile device runs the mobile wallet application (or mobile wallet application) 207.

The subscriber can indicate, using the mobile application 207 which transaction or other action he or she would like to perform. The indicated transaction 208 is sent to the mobile wallet platform 210 to be carried out by the platform. The transaction processor 216 (which may be similar to or the same as transaction processor 121 of FIG. 1) performs the transaction(s) specified by the (unbanked) subscriber 205. The transaction processor may implement various other components to perform the transaction including memory 217, (wireless) communication module 215, rules engine 210 and/or transaction database 225.

Performing the specified transactions may include communicating with the monetary transaction database 225 to determine whether the transaction is permissible based on data indicated in the unbanked subscriber's profile (for instance, whether the subscriber has enough eMoney in his or her stored value account, or has enough money in his or her bank account). Rules engine 220 may also be consulted to determine whether the subscriber has exceeded a specified number of allowed transactions. Then, if funds are available, and the transaction is otherwise permissible, the monetary transaction system can transfer money or eMoney 221 to or from an entity such as a user or agent (e.g. entity 222) to or from an establishment such as a retail store or agent company (e.g. entity 223).

In some cases, the monetary transaction system 210 application provides a web interface that allows subscribers to perform the same functions provided by the monetary transaction system application. For instance, mobile wallet application 207 may provide a web interface that allows a user to enroll for a mobile wallet. The web interface (or the mobile wallet application itself) receives a subscriber-initiated transaction over one of a plurality of channels (111 from FIG. 1) connected to the monetary transaction system 210. The web interface or mobile wallet application may prompt for and receive enrollment information (e.g. KYC information) for the (unbanked) subscriber 205 over at least one of the plurality of channels (e.g. web, point-of-sale (POS), interactive voice response (IVR, etc.). The web interface or mobile wallet application may then send activation instructions over the same or a different channel to activate the (unbanked) subscriber 205 and create a subscriber account for the (unbanked) subscriber.

Once the subscriber has an account, the monetary transaction system generates a corresponding mobile wallet for the unbanked subscriber (available via the web interface and/or the mobile wallet application. The system then presents the (unbanked) subscriber's account data associated with the mobile wallet and/or a notification indicating that enrollment was successful to the subscriber. Accordingly, the mobile wallet application or the web interface may be used to provide user enrollment functionality. It should also be understood that either the mobile wallet application or the web interface may be used to provide substantially all of the mobile wallet functionality described herein.

It should also be noted that the mobile device 206 may be any type of plan-based phone or tablet, or prepaid phone or tablet. Many subscribers, such as unbanked subscribers, may primarily use prepaid phones. The mobile wallet application 207 may be installed on both plan-based phones and prepaid phones. The mobile wallet application may be installed on the device's SIM card, or on the device's main memory. Accordingly, the monetary transaction system 200 may be accessed and used via substantially any type of plan-based or prepaid mobile device.

The components depicted in FIG. 1 can interoperate to provide a number of financial and other services including but not limited to enrolling a customer for a mobile wallet, adding a stored value account (either hosted by an electronic payment system or a third party), adding a bank/credit union account to a mobile wallet, adding a debit/credit card account to a mobile wallet, depositing funds in a mobile wallet, withdrawing funds from a mobile wallet, paying bills from a mobile wallet, topping up a prepaid mobile account through a mobile wallet, transferring funds through a mobile wallet, making in store purchases from a mobile wallet, or transferring money or eMoney from one business account to another business account (i.e. from one business's mobile vault to another business's mobile vault, as will be shown in FIG. 4).

FIG. 3A depicts a subscriber-to-subscriber eMoney transfer. In a merchant and distributor scenario, either or both of the merchant and the distributor (including any delivery personnel) may be subscribers. To perform such a transfer, subscriber A (301) enters some type of identification information identifying subscriber B (e.g. subscriber B's phone number) and an amount of money he or she wishes to transfer. The transaction processor 216 of the monetary transaction system 210 determines if there are sufficient funds to complete the transfer. If sufficient funds are available, the monetary transaction system 210 decrements subscriber A's account and credits subscriber B's account (302). The system then sends some kind of notification (e.g. SMS) to subscriber B indicating that a certain amount of money was transferred to their account. Subscriber A may also receive a notification that the transfer was successful. Accordingly, eMoney may be transferred between two mFS platform subscribers, one or both of which may be unbanked. The monetary transaction system 210 processes the subscribers' requests, updates the subscribers' eMoney balances, logs the transactions, and sends transaction information to a specified bank when needed.

FIG. 3B illustrates a subscriber-to-non-subscriber eMoney transfer. Accordingly, as mentioned above, either or both of the merchant and the distributor may be non-subscribers. In graphic 305, subscriber A wishes to send eMoney to another individual that is not a subscriber to the mFS platform. The transaction is initiated in the same fashion as the subscriber-to-subscriber transfer scenario. However, since non-subscriber B does not have a mobile wallet account, the monetary transaction system 210 cannot credit them with eMoney. Instead, the monetary transaction system 210 sends a notification (e.g. via SMS) to non-subscriber B with instructions for how to pick-up the transferred money, along with an authorization code (306). The monetary transaction system 210 puts a hold on subscriber A's account for the amount transferred. Subscriber B then has a specified number of days to pick up the cash before the hold expires and the amount is credited back to subscriber A's eMoney account by the monetary transaction system 210.

When non-subscriber B goes to pick up the money at an agent branch, the agent branch's manager or agent verifies the authorization code via an agent manager or agent mobile wallet application (that, in turn, accesses the mFS platform). Once the transfer has been validated, the agent gives the cash to non-subscriber B. The agent branch's mFS account is credited with the transfer amount (307) and the user leaves with the cash in hand (308). The mFS platform processes the transfer request, updates subscriber A's eMoney balance, logs the transaction, and sends transaction details to a platform-specified bank.

FIG. 4 depicts a physical environment and corresponding computer system architecture 400 for paying using mobile wallets to pay for delivered products.

As depicted in FIG. 4, delivery vehicle 404 physically delivers goods 403 from distribution center 401 to retail location 402 (i.e. to merchant 407). It should be noted that retail location 402 may include any location to which goods are distributed including stores, homes, business offices or other locations. Distribution center 401 may be one of a number of distribution centers owned and/or controlled by distributor 462. Delivery of goods 403 to retail location 402 can be part of delivery route that includes deliveries to one or more other retail locations. Thus, before arriving at retail location 402, delivery vehicle 404 may have already made other stops to deliver other goods to one or more other retail locations. Likewise, after leaving retail location 402, delivery vehicle 404 may make additional other stops to deliver other goods to one or more additional retail locations.

After arriving at retail location 402, goods 403 are removed from delivery vehicle 404 (e.g., by one or more of: merchant 403, merchant 403's employees, and delivery personnel 406) and left at retail location 402 for subsequent sale to patrons of the retail location.

Merchant 407 can use merchant mobile phone 408 (or another mobile device) for wireless (telephonic) communication, as well as running software applications, such as, for example, mobile wallet application 411. Delivery personnel 406 can use delivery mobile phone 409 for wireless telephonic communication as well as running software applications, such as, for example, invoicing application 412. Merchant mobile phone 408 and delivery mobile phone 409 can communicate wirelessly with (e.g., send data to, receive data from, issue commands to, etc.) electronic payment system 421 to utilize the functionality of electronic payment system 421 (i.e. monetary transaction system 210). Wireless communication can occur over a wide area wireless network, such as, for example, a cellular network. Collectively, electronic payment system 421, merchant mobile phone 408, and delivery mobile phone 409 represent a mobile payment platform (i.e. 210). Within this platform, the merchant may be an agent, and the retail location may be an agent company, and thus provide the appertaining functionality (described above) to subscribers and non-subscribers.

As depicted, electronic payment system 421 includes payment processor 422 (e.g., a payment processor used by payment handler 105), an invoice processor 423, merchant mobile wallet 424, and distributor mobile vault 426. Merchant mobile wallet 424 corresponds to merchant 407. Distributor mobile vault 426 further includes distributor mobile wallet 427 and distributor invoicing data 428. Distributor invoicing data 428 defines an invoicing formation for distributor 462. Distributor mobile vault 426 corresponds to distributor 462. Merchant mobile wallet 424 and distributor mobile vault 426 can be stored in a database (e.g., database 108).

Although not depicted, various other modules from the architecture of FIGS. 1 and/or 2 can also be included electronic payment system 421. The modules expressly depicted in FIG. 4 can interoperate with these other modules as appropriate to facilitate desired functionality.

Delivery personnel 406 can use invoicing application 412 to interact with electronic payment system 421 in a limited way on behalf of distributor 462. Upon delivery of goods 403 to retail location 402, delivery personnel can also deliver an invoice to merchant 407. In some embodiments, the invoice is a paper invoice, such as, for example, invoice 461. Invoice 461 indicates that goods 403 were purchased for amount 463.

In other embodiments, the invoice is an electronic invoice. For example, delivery personnel 406 can use invoicing application 412 to send invoice submission data 429 to invoice processor 423. (Alternatively, the invoice submission data 429 may be sent via a batch file from distributor 462). Invoice processor 423 can receive invoice submission data 429 from invoicing application 412. Invoice submission data 429 can indicate that goods 403 are valued at a specified amount and were physically delivered retail location 402. Invoice processor 423 can refer to distributor invoicing data 428. Invoice processor 423 can generate electronic invoice 431 based on the invoice submission data 429 and the distributor invoicing data 428. Invoice processor 423 can submit electronic invoice 431 to merchant mobile phone 408 on behalf of distributor 462. Electronic invoice 431 indicates that goods 403 were purchased for amount 463. Invoice processor 423 can record generation of invoice 431 in distributor mobile vault 426.

Mobile wallet application 411 can receive invoice 431 from electronic payment system 421. In response to receiving invoice 431, mobile wallet application 411 can indicate receipt of invoice 431 at a user-interface (e.g., display screen) of merchant mobile phone 408.

Upon receiving an invoice (whether it be a paper invoice or an electronic invoice) merchant 407 can log into electronic payment system 421 and access merchant mobile wallet 424 through mobile wallet application 411. Merchant 407 can enter commands through a user-interface (e.g., touch screen or keypad) to request that the invoice (e.g., invoice 461 or invoice 431) be paid partially or in full. Mobile wallet application 411 can send payment instructions 432 to payment processor 422. Payment instructions 432 indicate that amount 463 is to be paid from merchant 407 to distributor 462. Payment processor 422 can validate that the balance of funds in merchant mobile wallet 424 is sufficient to pay amount 463. When the balance of funds is sufficient, payment processor 422 s debits 441 amount 463 from merchant mobile wallet 424 and credits 442 amount 463 to distributor mobile wallet 427.

Payment processor 422 indicates to invoice processor 423 that invoice 431 or invoice 461 was paid as appropriate. Invoice processor 423 receives the indication that invoice 431 or invoice 461 was paid. Invoice processor 423 records the indication that invoice 431 or invoice 461 was paid in the distributor mobile vault 426. Payment processor 422 (or a separate notification module) can send payment received notification 434 (e.g., a receipt) to mobile wallet application 411. Mobile wallet application 411 can present payment received notification 434 to merchant 407 through a user-interface (e.g., a display screen). Accordingly, merchant 407 is provided verification when an invoice is paid.

Payment processor 422 (or the separate notification module) can send payment received notification 433 to invoicing application 412. Invoicing application 412 can present payment received notification 433 to delivery personnel 406 through a user-interface (e.g., a display screen). Accordingly, delivery personnel 406 are provided verification when an invoice is paid. In response to seeing presentation of payment received notification 433, delivery personnel 406 can leave retail location 402 and delivery other goods to a next delivery stop or return to distribution center 401. The transaction is efficient and saves time relative to a currency based transaction. Accordingly, delivery personnel 406 can makes more deliveries in a specified time period (e.g., a shift or a day).

The features of mobile telephone applications, such as, for example, mobile wallet application 411 and invoice application 412, can be adjusted for mobile telephone capabilities. For example, a lower function, “basic” mobile wallet application may be configured to work on lower capability mobile phones. The basic mobile wallet application can be used for merchant mobile wallet payment for goods. The basic application can provide electronically time-stamped authentication and authorization of payment and automatic deposit.

An “enhanced” mobile wallet application can be configured to work on higher capability mobile phones such as smart phones and tablets. In addition to features of the basic application, the enhanced application also has the capability to tie into a distributor's inventory to produce other features, including: automatic notification to merchant of pending delivery, automatic notification of delays, real-time inventory adjustments that re-calculate the amount due, and automatically close out accounts receivable (“A/R”) account upon completion of a transaction.

In addition to linking existing bank accounts to the mobile wallet, the electronic payment system 421 maintains a stored value account for real-time payment of services. For at least some implementations, the electronic payment system may partner with a local bank to provide pre-paid stored value accounts for each mobile wallet (including the distributor's mobile wallet, the delivery person's mobile wallet (which may be the same as or an extension of the distributor's mobile wallet), and the merchant's mobile wallet. These stored value accounts provide the basis for the exchange of funds between each of the program participants, whether they are distributors, merchants, consumers, agents, or companies providing services on the platform.

A partner bank is used to hold all of the stored value accounts and support settlements between the accounts. Agents deposit funds into and withdraw funds from the bank directly. Distributors, merchants, and consumers interact with agents to deposit and withdraw funds. Integration into a partner bank supports the activation and maintenance of each of the stored value accounts. While the electronic payment system 421 manages the real-time balance of each end-user stored value account, the platform interacts with the bank to move funds from one account to the other as a means of settling the transactions. The partner bank also supports settlement with program participants who don't have an account with the partner bank. The partner bank may support settlements with payment gateways, bill payment providers, and international remittance providers.

Other financial service providers such as bill payment aggregators and international remittance providers are also integrated into the electronic payment system 421. These service providers offer end-users the ability to pay their bills and send money to others. The recipients don't necessarily need to be subscribers to the program to receive their funds (as explained above with regard to FIG. 3B). International remittance providers support the ability to both send money as well as receive money transfers in real time into the stored value accounts.

A reconciliation report may be generated and accessible through a portal provided by the electronic payment system 421 to ensure delivery personnel invoices (431) and receipts (433) are reconciled with merchant orders and inventory. The electronic payment system 421 also allows users to view the account balance and transaction history of the driver account and distribution center stored value accounts. Delivery personnel/distributors are able to receive and process payments for client products from merchants using cash, credit cards, debit cards, or a mobile wallet stored value account. Delivery personnel/distributors have the ability to deposit cash in nearby banks or with program agents in order to limit the amount of cash on hand as they complete their deliveries.

Merchants establish a stored value account with their mobile wallet 411 that can be used to make mobile payments to distributors or receive payments from consumers using cash, credit cards, debit cards, or a mobile wallet platform stored value account. The mobile wallet application 411 allows merchants to make electronic bill payments or transfer money from their mobile phone on behalf of customers who have not registered for the client mobile wallet stored value account.

In addition to processing financial transactions, the merchant's mobile wallet account applications allow them to manage their user profile including the linking and unlinking of payment instruments such as credit cards and checking accounts, updating their personal information including address, password and PIN, and methods by which the platform sends receipts, alerts and reminders. Changes made on any channel are updated and stored in the subscriber profile and are applied to each channel (i.e.—a password update on a mobile wallet application applies also to the Web client or USSD client).

The electronic payment system 421 works with all of the program participants to manage fraud and unauthorized access to data on the platform. Every transaction on the electronic payment system 421 is considered an auditable event and is stored with the account information of the person executing the transaction, a unique transaction ID, and time stamp. This data is aggregated on a centralized logging server where it is indexed and made available for reporting and fraud research. Likewise, periodic (e.g. daily) reports are generated to highlight suspicious activity based on patterns, thresholds, and velocities. The electronic payment system 421 also utilizes real-time transactions monitoring and filtering by validating transaction limits and velocities of every transaction to diminish fraudulent usage.

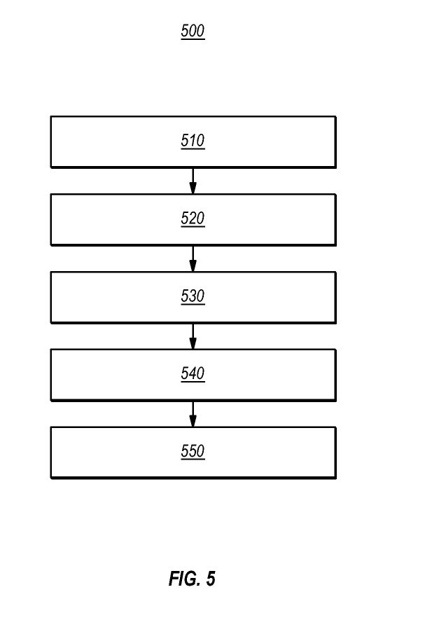

In one embodiment, as described in the flowchart 500 of FIG. 5, a computer system is provided. The computer system may be any type of computing device that has one or more processors and some type of memory. The computer system also includes a computer-readable medium that has computer-executable instructions stored on it that, when executed by the one or more processors, causes the computer system to perform a method for allowing a merchant to pay a distributor for delivered goods using an electronic payment system. The method includes receiving a payment instruction 432 from a merchant 407 in step 510. The payment instruction indicates that a distributor's invoice for a specified amount 463 is to be paid from the merchant's mobile wallet 411. The invoice is generated for goods 403 that were physically delivered from the distributor 462 to the merchant 407. At least in this embodiment, both the merchant and the distributor have mobile wallets (411 and 427, respectively). In other embodiments, one or the other may not be subscribers to the electronic payment system 421 and may not have a mobile wallet.

The electronic payment system 421 validates that the merchant's mobile wallet 411 has a balance of funds sufficient to pay the amount 463 specified in the invoice 431 in step 520, and debits the merchant's mobile wallet by the specified amount of funds in step 530. The electronic payment system 421 then credits the distributor's mobile wallet by the specified amount of funds in step 540 and sends a notification 433 to the distributor indicating that the invoice has been paid in step 550. Accordingly, a business may be able to pay an invoice using a mobile wallet quickly and seamlessly. The delivery person/distributor thus does not have to deal with cash (at least in this transaction), and can avoid the logistical hassles of physical cash.

Thus, in general, a mobile vault and corresponding applications, enable a distributor to accept mobile wallet payments from merchants, increasing the number of merchants drivers can reach within a day while reducing the amount of cash transactions per route. Moreover, a merchant mobile wallet can be used for additional services such as remittances, bill payments, airtime top-up and purchases.

Embodiments of the invention can adhere to Know Your Customer (KYC) rules in the US by performing Customer Identification Program (CIP) checks as required by the Bank Secrecy Act and US PATRIOT Act. A minimum amount of information can be gathered about a customer, such as, for example, First Name, Last Name, Date of Birth, Government ID Type, Government ID Number, Address. The CIP processes are designed to validate customer identity against government blacklists and assists in the prevention of money laundering and terrorist financing. A combination of non-documentary and documentary verification can be used to ensure beyond a reasonable doubt the identity of the customer.

Non-Documentary Verification can occur through the presentment of the information that was collected from the user to an external third party, such as, for example, Lexis Nexis. Documentary Verification can occur if non-documentary verification fails, then the user is asked to present an unexpired government ID. Various differ forms of identification including Driver's license, Passport, Alien identification (e.g., green card or work visa), and Mexican Consular identification card, can be accepted.

Embodiments of the invention can perform Anti-Money Laundering (AML) and Combating the Financing of Terrorism (CFT) checks. AML and CFT checks can be performed using transaction monitoring methods to flag names and suspicious transactions for further investigation. The electronic payment system can perform AML and CFT checks on all electronic financial transactions to ensure that electronic funds are not being used for money laundering or terrorism. Transaction limits can be placed on user accounts. The transaction limits are fully configurable for each particular use case, channel and payment method that allows maximum flexibility to restrict higher risk use cases. Velocity checks can also be performed. Velocity Checks ensure that subscribers are not abusing the electronic payment system within the allowable limits.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A computer system comprising the following:
one or more processors;
system memory;
one or more computer-readable storage media having stored thereon computer-executable instructions that, when executed by the one or more processors, causes the computing system to perform a method for allowing a merchant to pay a distributor for delivered goods using an electronic payment system, the method comprising the following:
receiving a payment instruction from a merchant, the payment instruction indicating that a distributor's invoice for a specified amount is to be paid from the merchant's mobile wallet, the invoice being generated for one or more goods physically delivered from the distributor to the merchant, the merchant and the distributor both having mobile wallets;
validating that the merchant's mobile wallet has a balance of funds sufficient to pay the amount specified in the invoice;
debiting the merchant's mobile wallet by the specified amount of funds;
crediting the distributor's mobile wallet by the specified amount of funds; and
sending a notification to the distributor indicating that the invoice has been paid.

2. The computer system of claim 1, wherein the merchant's payment instruction is received from the merchant's mobile device using wireless communication.

3. The computer system of claim 2, further comprising sending a payment received notification to the merchant's mobile device.

4. The computer system of claim 1, wherein the indication sent to the distributor is sent to the distributor's mobile device using wireless communication.

5. The computer system of claim 1, wherein the distributor's invoice is submitted to the merchant's mobile device by a delivery person on behalf of the distributor.

6. The computer system of claim 5, further comprising, prior to receiving the payment instruction from the merchant mobile device, receiving invoice submission data from the delivery person's mobile device using wireless communication, the invoice submission data indicating that the merchant is to be invoiced in the specified amount for the physically delivered goods.

7. The computer system of claim 6, further comprising sending an electronic invoice to the merchant's mobile device in response to receiving a request from the merchant and in response to receiving the invoice submission data from the delivery person on behalf of the distributor, the electronic invoice indicating that the merchant owes the distributor the specified amount for the physically delivered goods.

8. The computer system of claim 7, wherein receiving a payment instruction from a merchant mobile device using wireless communication comprises receiving a payment instruction indicating that the electronic invoice is to be paid from the merchant's mobile wallet.

9. The computer system of claim 7, wherein receiving a payment instruction from the merchant mobile device using wireless communication comprises receiving a payment instruction indicating that a paper invoice is to be paid from the merchant's mobile wallet.

10. The computer system of claim 1, further comprising sending the merchant an additional notification notifying the merchant of a pending delivery.

11. The computer system of claim 10, wherein the additional notification indicates a delivery date and time window in which the deliver is to occur.

12. The computer system of claim 11, wherein subsequent notifications are sent to the merchant automatically upon the occurrence of a delay.

13. The computer system of claim 1, further comprising sending the merchant a real-time inventory adjustments notification that indicates the merchant's newly received goods.

14. The computer system of claim 1, further comprising automatically closing out a merchant accounts receivable (A/R) account upon completion of the transaction.

15. The computer system of claim 1, wherein the electronic payment system utilizes an internal processor to maintain individual merchant mobile wallet balances in addition to distributor mobile wallet balances.

16. A mobile payment platform, the mobile payment platform including:
an electronic payment system, the electronic payment system including one or more computer storage devices having stored thereon computer executable instructions representing a payment processor, an invoice processor, a merchant mobile wallet, and a distributor mobile vault, the distributor mobile vault including a distributor mobile wallet and distributor invoicing data, the merchant mobile wallet for a merchant, the distributor mobile vault for a distributor;
a distributor mobile device, the distributor mobile device including one or more computer storage devices having stored thereon computer executable instructions representing an invoicing application; and
an merchant mobile device, the merchant mobile device including one or more computer storage devices having stored thereon computer executable instructions representing a mobile wallet application; and
wherein the invoice processor is configured to:
receive invoice submission data from the distributor's mobile device, the invoice submission data indicating that goods valued at a specified amount were physically delivered to the merchant;
generate an electronic invoice based on the invoice submission
submit the generated electronic invoice to the merchant's mobile device;
record generation of the electronic invoice in the distributor's mobile vault;
receive an indication that an electronic invoice has been paid; and
record the indication that the electronic invoice has been paid in the distributor's mobile vault.

17. The mobile payment platform of claim 16, wherein the payment processor is configured to:
receive a payment instruction from a merchant, the payment instruction indicating that a distributor's invoice for a specified amount is to be paid from the merchant's mobile wallet, the invoice being generated for one or more goods physically delivered from the distributor to the merchant, the merchant and the distributor both having mobile wallets;
validate that the merchant's mobile wallet has a balance of funds sufficient to pay the amount specified in the invoice;
debit the merchant's mobile wallet by the specified amount of funds;
credit the distributor's mobile wallet by the specified amount of funds; and
send a notification to the distributor indicating that the invoice has been paid.

18. The mobile payment platform of claim 16, wherein the generated electronic invoice is submitted to the merchant's mobile device by a delivery person on behalf of the distributor.

19. The mobile payment platform of claim 16, the merchant uses the mobile payment platform for performing at least one of the following in addition to making payments for received goods: bill payments, remittances, mobile phone airtime top-up and retail purchases.

20. A mobile payment platform, the mobile payment platform including:
an electronic payment system, the electronic payment system including one or more computer storage devices having stored thereon computer executable instructions representing a payment processor, an invoice processor, a merchant mobile wallet, and a distributor mobile vault, the distributor mobile vault including a distributor mobile wallet and distributor invoicing data, the merchant mobile wallet for a merchant, the distributor mobile vault for a distributor;
a distributor mobile device, the distributor mobile device including one or more computer storage devices having stored thereon computer executable instructions representing an invoicing application; and
an merchant mobile device, the merchant mobile device including one or more computer storage devices having stored thereon computer executable instructions representing a mobile wallet application; and
wherein the invoice processor is configured to:
receive invoice submission data from the distributor's mobile device, the invoice submission data indicating that goods valued at a specified amount were physically delivered to the merchant;
generate an electronic invoice based on the invoice submission data;
submit the generated electronic invoice to the merchant's mobile device;
record generation of the electronic invoice in the distributor's mobile vault;
receive an indication that an electronic invoice has been paid; and
record the indication that the electronic invoice has been paid in the distributor's mobile vault; and
wherein the payment processor is configured to:
receive a payment instruction from a merchant, the payment instruction indicating that a distributor's invoice for a specified amount is to be paid from the merchant's mobile wallet, the invoice being generated for one or more goods physically delivered from the distributor to the merchant, the merchant and the distributor both having mobile wallets;
validate that the merchant's mobile wallet has a balance of funds sufficient to pay the amount specified in the invoice;
debit the merchant's mobile wallet by the specified amount of funds;
credit the distributor's mobile wallet by the specified amount of funds; and
send a notification to the distributor indicating that the invoice has been paid.
